(19) United States
(12) Patent Application Publication
(10) Pub. No.: US 2017/0024800 A1
(43) Pub. Date: Jan. 26, 2017

(54) NOTIFICATION SERVICES FOR RETURNING AN ITEM

(71) Applicant: eBay Inc., San Jose, CA (US)

(72) Inventor: Ishan Shah, King of Prussia, PA (US)

(21) Appl. No.: 14/807,803

(22) Filed: Jul. 23, 2015

(51) Int. Cl. G06Q 30/06; H04L 12/58; H04L 29/08

(52) U.S. Cl. CPC G06Q 30/0633; H04L 67/02; H04L 51/20

(57) ABSTRACT

In various example embodiments, a system and method for digital lists of items are presented. A database can store purchase information associated with purchased items by a user. Additionally, an application interface can receive a return request. The return request can include an item identifier that corresponds to the purchased item. Furthermore, a notification management circuitry, including one or more processors, can be configured to access, using the item identifier, the purchase information associated with the purchased item. The purchase information can include a vendor identifier. Moreover, the notification management circuitry can detect a notification event based on the purchase information, and cause a presentation of a notification message in response to the detected notification event.

### TECHNICAL FIELD

Embodiments of the present disclosure relate generally to data processing and, more particularly, but not by way of limitation, to notification services for returning a purchased item within a network environment.

### BACKGROUND

Conventionally, an online marketplace can provide listing services for items to purchased, such as a wish list or gift registry. For example, a user can browse a website of the online marketplace and select one or more items (e.g., products, garments) to be included in a digital list that is linked to the user account of the user. The online marketplace stores the digital list for later retrieval by the user. The digital list may include information about a selected item, such as a price offered for each item. The user can access the online marketplace to view the digital list to be reminded of the selected item that the user has added to the digital list. Additionally, a user may be more likely to purchase the selected item, if the selected item can be easily returned back.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram illustrating an example embodiment of the notification system of FIG. 1 including multiple modules forming at least a portion of the client-server system of FIG. 1.

FIGS. 3-5 are interface diagrams illustrating example user interfaces of a web resource with multiple display elements delivered to the user device by the notification system, according to an example embodiment.

FIG. 6 is a block diagram illustrating an example data memory system including a number of data structures of the notification system, in accordance with an example embodiment.

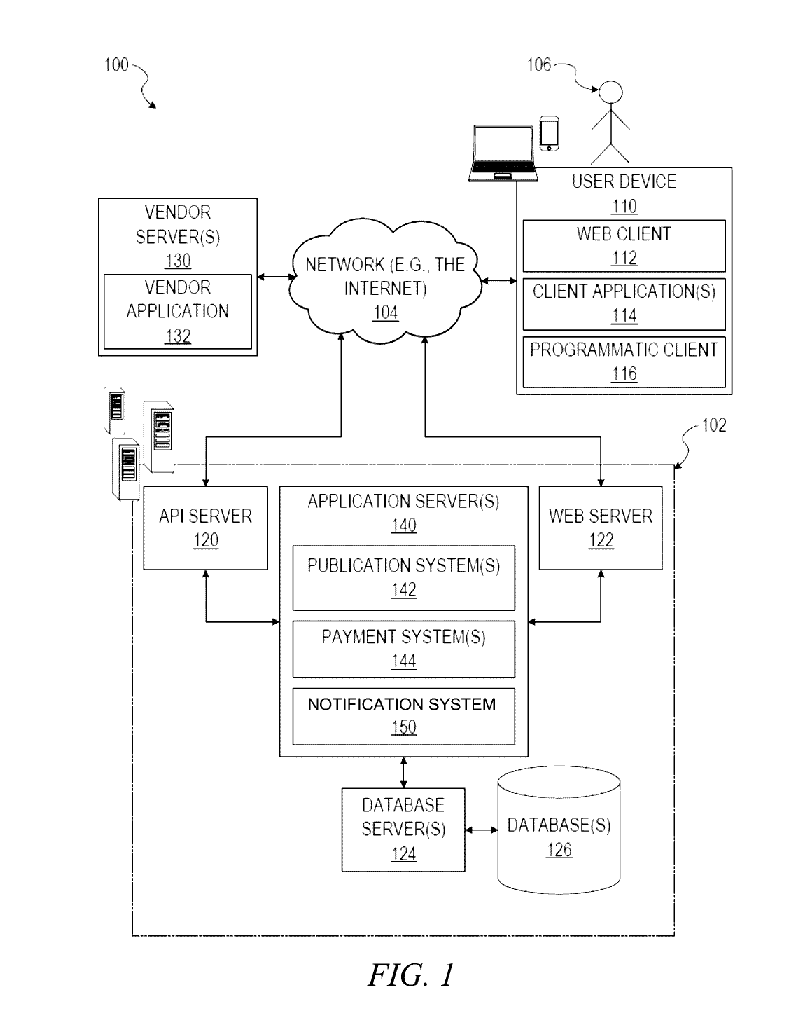

FIG. 1 is a flowchart illustrating an example method of providing notifications, in accordance with an example embodiment.

FIG. 8 is flowchart illustrating example method of detecting a notification event of FIG. 7, in accordance with an example embodiment.

FIG. 9 is a block diagram illustrating components of a machine, according to some example embodiments, able to read instructions from a machine-readable medium and perform any one or more of the methodologies discussed herein.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In some instances, a user can forget to return one or more purchased items. Additionally, the purchased items that the user intended to be returned can pile up, which may make the user reluctant to make more purchases. Moreover, the user may be hesitant to make a future purchase, because of issues surrounding the return of a purchased item. As a result, a store can lose a potential selling opportunity. Therefore, by using notification services to make it easier to return a purchased item, the user is more likely to make a purchase.

In various example embodiments, a notification system provides to users an item list for creating, storing, and updating a digital list. The notification system interfaces with multiple vendors and users, as well as multiple user devices of each user. For example, vendors can register vendor accounts that include information regarding one or more items of the respective vendors. Additionally, users can register user accounts for accessing and facilitating notification services provided by the notification system. Users can select items of the vendors to generate a digital list (e.g., wish list, return item list). The digital list can also include a previously purchased list of recently purchased items associated with the user. In some instances, the user can select items from a previously purchased list to add to the return item list. The notification system can transmit a notification message to the user based on a notification event. A notification event can include the return item being within a close proximity of the vendor.

For example, a user can add an item to return to a specific vendor to the digital list in a number of ways. In one way, a user can add an item to a digital list by scanning an item or a tag of the item using, for example, a mobile device interfaced with the notification system. In an example embodiment, users can add items to the digital list by scanning a bar-code or any suitable identifier using a camera or sensor of a mobile device. Scanning can also include taking a picture of the item. The mobile device can use the bi-directional, single-sign-on interface to send the return request to the notification system. The digital list is updated by adding the selected item for return.

In another way, users can add items to the digital list by selecting the items online from a previously purchased list. For example, users can browse items that have been recently purchased using a mobile application, a website of a vendor, or a software application of the notification system.

In example embodiments, a bi-directional, single sign-on interface allows the user to log into any of these applications and websites using the same login information. List data (e.g., return list, digital list) can be stored in a centralized and secured repository so that users can access their lists using a plurality of user devices. Furthermore, the notification system can provide push and/or pull notifications based on global positioning system (GPS) location, proximity from store, event, time, etc. Additionally or alternatively, users can share list data and/or notifications with other people.

In one aspect, among others, some example embodiments described herein can improve data organization and can improve sales by making a user more inclined to make a purchase. For example, a user can be more inclined to make a purchased, given that the notification system can remind the user to return the purchased item. Moreover, users can generate a digital list having items for return from different vendors and shared with other people. The notification system disclosed herein provides a single list for multiple vendors and sends notification messages to remind the user. For example, the notification system can provide a notification message to the user when the user is within proximity of a store that has an item on the user's digital list. Furthermore, the notification system sends notifications to the user based on calendar event, or a characteristic that affect a user's ability to return the item or affects the timing of a user's decision to return (reminder of an business trip, and so forth).

With reference to FIG. 1, an example embodiment of high-level client-server-based network architecture 100 is shown. A networked system 102, in the example forms of a network-based marketplace or payment system, provides server-side functionality via a network 104 (e.g., the Internet or wide area network (WAN)) to one or more user device 110 (also referred to as a “client device”). FIG. 1 illustrates, for example, a web client 112, client application(s) 114, and a programmatic client 116 executing on user device 110.

The user device 110 may comprise, but are not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may utilize to access the networked system 102. In some embodiments, the user device 110 may comprise a display module (not shown) to display information (e.g., in the form of user interfaces). In further embodiments, the user device 110 may comprise one or more of a touch screen, accelerometer, gyroscope, camera, microphone, global positioning system (GPS) device, and so forth. The user device 110 may be a device that is used by a user to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. One or more user 106 may be a person, a machine, or other means of interacting with user device 110. In embodiments, the user 106 is not part of the network architecture 100, but may interact with the network architecture 100 via user device 110 or another means. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each user device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given user device 110, then this application is configured to locally provide the user interface and at least some of the functionalities with the application configured to communicate with the networked system 102, on an as-needed basis, for data and/or processing capabilities not locally available (e.g., access to a database of items available for sale, to authenticate a user, to verify a method of payment, etc.). Conversely, if the e-commerce site application is not included in the user device 110, the user device 110 may use its web browser to access the e-commerce site (or a variant thereof) hosted on the networked system 102.

One or more users 106 may be a person, a machine, or other means of interacting with the user device 110. In example embodiments, the user 106 is not part of the network architecture 100, but may interact with the network architecture 100 via the user device 110 or other means. For instance, the user 106 provides input (e.g., touch screen input or alphanumeric input) to the user device 110 and the input is communicated to the networked system 102 via the network 104. In this instance, the networked system 102, in response to receiving the input from the user 106, communicates information to the user device 110 via the network 104 to be presented to the user 106. In this way, the user 106 interacts with the networked system 102 using the user device 110.

An application program interface (API) server 120 and a web server 122 are coupled to, and provide programmatic and web interfaces respectively to, one or more application server 140. The application server(s) 140 may host one or more publication system 142, payment system 144, and a notification system 150, each of which may comprise one or more modules or applications and each of which may be embodied as hardware, software, firmware, or any combination thereof. The application server(s) 140 are, in turn, shown to be coupled to one or more database server 124 that facilitate access to one or more information storage repositories or database(s) 126. In an example embodiment, the database(s) 126 is a storage device that stores information to be posted (e.g., publications or listings) to the publication system(s) 142. The database(s) 126 may also store digital item information in accordance with example embodiments.

Additionally, a vendor application 132, executing on vendor server(s) 130, is shown as having programmatic access to the networked system 102 via the programmatic interface provided by the API server 120. For example, the vendor application 132, utilizing information retrieved from the networked system 102, supports one or more features or functions on a website hosted by the vendor. The vendor website, for example, provides one or more promotional, marketplace, or payment functions that are supported by the relevant applications of the networked system 102.

The publication system(s) 142 may provide a number of publication functions and services to a user 106 that accesses the networked system 102. The payment system(s) 144 may likewise provide a number of functions to perform or facilitate payments and transactions. While the publication system(s) 142 and payment system(s) 144 are shown in FIG. 1 to both form part of the networked system 102, it will be appreciated that, in alternative embodiments, each system 142 and 144 may form part of a payment service that is separate and distinct from the networked system 102. In some embodiments, the payment system(s) 144 may form part of the publication system 142.

The notification system 150 provides functionality operable to perform various listing and notification services using the user provided data. For example, the notification system 150 may access the digital list from the databases 126, the vendor server(s) 130, the publication system(s) 142, and other sources. One or more vendor server 130 register vendor accounts with the notification system 150.

Moreover, one or more user 106 can register respective user accounts with the notification system 150. Furthermore, each user 106 accesses the user's user account with one or more devices, such as the user device 106, to access the digital list data. In this way, the notification system 150 provides centralized account data that is accessible by multiple user devices of the user 106, should the user use multiple devices.

Additionally or alternatively, the notification system 150 links the user's 106 activities on one device with the multiple devices of the user 106. As an illustrative example, the user 106 adds items to be returned using a desktop computer at home and then receives notifications for the added item based on the user's location as determined by the user's 106 mobile device. In example embodiments, the notification system 150 stores device identifiers for tracking and/or addressing the devices of the user 106. For example, device identifiers can be used to facilitate the sending of notifications to each user device 106. A unique Device identifier (UDID) is an example of a device identifier. Additionally, a media access control address (MAC address) is another example of a device identifier.

In some instances, the notification system 150 receives user input that specifies one or more notification attributes. Notification attributes correspond to location-based and/or event-based attributes that specify a notification event that triggers a notification to be sent to the user 106. Accordingly, the notification system 150 monitors for notification events specified by the notification attribute. In response to detecting a notification event, the notification system 150 provides to the user devices 110 linked to the user 106 a notification message(s).

In example embodiments, the notification message includes a textual, graphical, and/or audible message that provides a reminder to the user 106 of the item to be returned from the digital list. Additionally or alternatively, the notification message includes a suggestion to purchase a suggested item from the vendor while the user is returning the purchased item. The suggested item can be from a wish list previously generated for the user. Additionally or alternatively, the notification message includes a graphical interface element that can be selected to share the notification with another user and/or a graphical interface element that can be selected to have the items delivered to the user.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system(s) 142, payment system(s) 144, and notification system 150 could also be implemented as standalone software programs, which do not necessarily have networking capabilities.

The web client 112 may access the notification system 150 via the web interface supported by the web server 122. Similarly, the programmatic client 116 accesses the various services and functions provided by the notification system 150 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

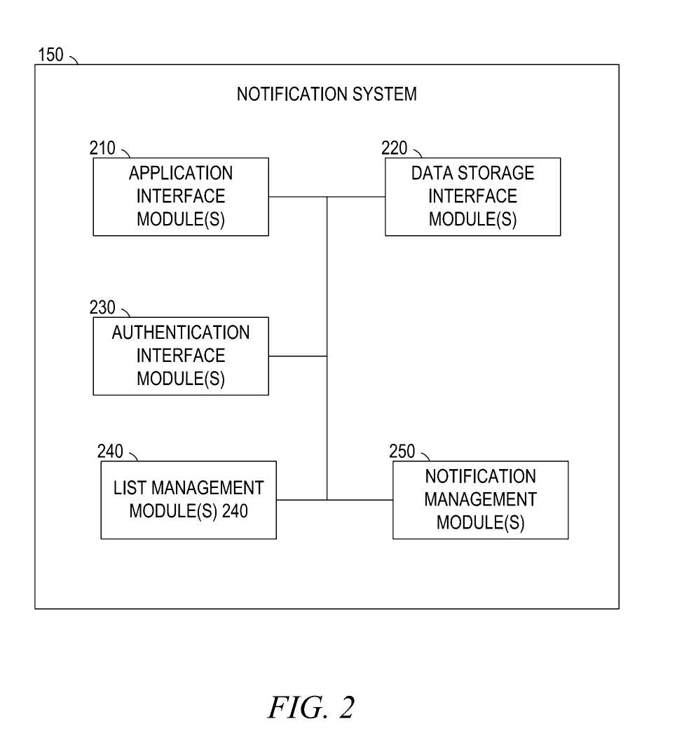

FIG. 2 is a block diagram illustrating an example embodiment of the notification system 150 of FIG. 1 including multiple modules forming at least a portion of the network architecture 100 of FIG. 1. The modules 210-250 of the illustrated notification system 150 include an application interface module(s) 210, a data storage interface module(s) 220, an authentication interface module(s) 230, a list management module(s) 240, and a notification management module(s) 250. In some embodiments, the components of the notification system 150 are included in the application server(s) 140 of FIG. 1. However, it will be appreciated that in alternative embodiments, one or more components of the notification system 150 described below are included, additionally or alternatively, in other devices, such as one or more of the user device 110 and/or the vendor server(s) 130 of FIG. 1. It will also be appreciated that the notification system 150 are deployed in systems other than online marketplaces.

The modules 210-250 of the notification system 150 are hosted on dedicated or shared server machines (not shown) that are communicatively coupled to enable communications between server machines. One or more of the modules 210-250 are deployed in one or more datacenters. Each of the modules 210-250 is communicatively coupled (e.g., via appropriate interfaces) to the other modules 210-250 and to various data sources, so as to allow information to be passed between the modules 210-250 of the notification system 150 or so as to allow the modules 210-250 to share and access common data. The various modules 210-250 of the notification system 150 furthermore access one or more database 126 via the database server(s) 124.

The application interface module(s) 210 is a hardware-implemented module that facilitates communication of data between the notification system 150 and the user device 110, the vendor server(s) 130, and other devices connected to the network 104. In particular, the application interface module(s) 210 provides a user-facing side for interfacing with one or more user devices 110 and a vendor-facing side for interfacing with one or more vendor server(s) 130, thus providing a bi-directional interface.

As stated, the application interface module(s) 210 includes a vendor-facing side for interfacing with one or more vendor server 130. For example, the application interface module(s) 210 interfaces with the API server 120 to provide a programmatic interface to the vendor application 132 and/or to provide a web interface to the vendor application client 112. As such, the application interface module(s) 210 facilitates the providing of functions, webpages, data, code, and/or the like web resources between the notification system 150 and the vendor application, as described in greater detail below.

The data storage interface module(s) 220 is a hardware-implemented module that facilitates accessing data for the notification system 150. In an example embodiment, the data storage interface module(s) 220 interfaces with the database(s) 126 of FIG. 1 to access one or more user accounts, vendor accounts, previously purchased items, digital lists, and/or vendor-item lists.

The authentication interface module(s) 230 is a hardware-implemented module that facilitates authenticating and authorizing devices that are communicatively coupled with the notification system 150. In operation, the authentication interface module(s) 230 receives authentication requests from a number of devices, such as, but not limited to, the user device 110 and/or the vendor server(s) 130 of FIG. 1. In example embodiments, an authentication request is a data communication that is indicative of a request for authentication and includes authentication data. For example, authentication data includes identifier (e.g., a user or vendor identifier) and credential (e.g., password) data.

In example embodiments, the authentication interface module(s) 230 facilitates single-sign-on functionality. For example, the authentication interface module(s) 230 receives authentication data from the user 106. The authentication data supplied by the user 106 is then used by the authentication interface module(s) 230 to support the authentication of the user 106 to one or more vendor servers 130.

The authentication interface module(s) 230 uses the authentication data in a number of ways to authenticate the user 106 with one or more vendors 130. For example, the authentication interface module(s) 230 passes authentication data directly to one or more vendor server 130 as part of a second sign-on process. The authentication interface module(s) 230 uses the authentication information to retrieve other user identification and user credential information stored within the notification system 150. The other user identification and user credential information are used as authentication for one or more vendor server 130. The authentication interface module(s) 230 stores and caches the authentication data and uses the authentication data at a time a request for vendor services is made by the user 106.

The authentication interface module(s) 230 grants access to listing services provided by the notification system 150. In example embodiments, the access can be restricted access to protect privacy. For example, the authentication interface module(s) 230 grants the user device 110 access to a user account linked to the authentication data provided by the user device 110, and denies access to user accounts not linked to the authentication data provided by the user device 110.

The list management module(s) 240 is a hardware-implemented module that facilitates maintaining the digital lists (e.g., return list) of the users of the notification system 150. In operation, the list management module(s) 240 can receive a number of requests from users and vendors. For example, the list management module(s) 240 receives add-item, remove-item, edit-item, share-item, and the like requests from users. The list management module(s) 240 receives notify-users and query requests from vendors. A notify user request is a request to provide a notification (e.g., an alert, promotion, discount, sale, and/or the like) to users having an identified item of the vendor and/or any items from the vendor within the user's digital list.

The notification management module(s) 250 is a hardware-implemented module that facilitates providing users notifications related to their respective digital lists. In operation, notification management module(s) 250 monitors for notification events related to items of the digital lists. Notification events trigger the notification management module(s) 250 to provide notification messages to one or more users.

In operation, the notification system 150 receives data from one or more vendor server 130 and the one or more user devices 110, e.g., via the application interface module(s) 210. The received data from the vendor server(s) 130 correspond to a number of inputs or requests related to, for example, authentication; creating or editing vendor accounts; adding, removing, and editing vendor-item lists; pushing notifications to users; and/or requesting analytics, as described below in greater detail. Additionally or alternatively, the received data from the user devices 110 correspond to a number of inputs or requests related to, for example, authentication; creating or editing user accounts; adding, removing, or editing digital lists; sharing data (e.g., sharing selected items and/or notifications); and/or requesting delivery, as described below in greater detail.

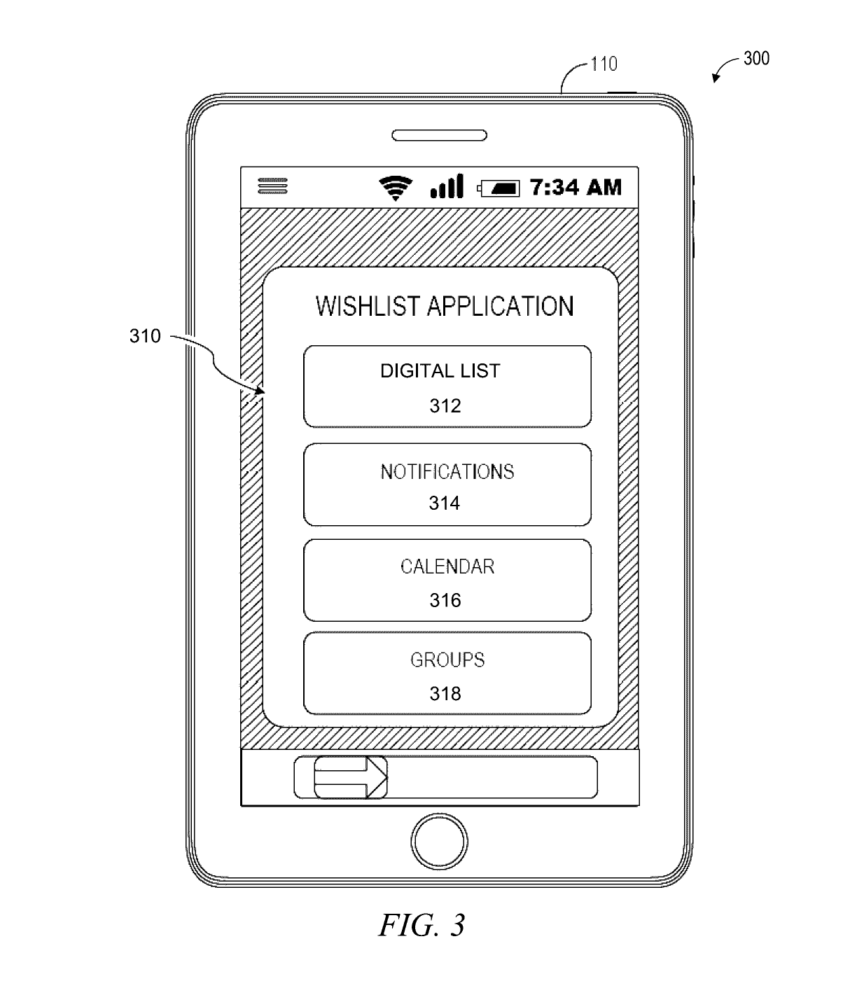

FIGS. 3-5 are interface diagrams illustrating example user interfaces 300, 400, 500, 600 of a web resource with multiple display elements delivered to the user device 110 by the notification system 150, according to an example embodiment. As used herein, a web resource corresponds to data and/or code delivered to the user device 110 over the network 104 to render a webpage, or to be processed and/or rendered by a software application executing on the user device 110.

FIG. 3 is an interface diagram illustrating a user interface 300 including the user device 110 rendering a first frame 310 of the web resource providing listing services. In an example embodiment, the first frame 310 corresponds to a display, such as a “home screen,” of a software application or web application interfaced with the notification system 150. The first frame 310 is presented to the user in response to a successful authentication process, e.g., initiated via the user interface 300 of FIG. 3. User input received by the first frame 310 from the user is transmitted to the notification system 150.

The first frame 310 includes a number of control elements that are user-selectable to access features and/or display information of the notification system 150. For example, a digital list 312 can be selected by the user to access a user interface displaying listing information regarding the user's digital list. In some instances, the digital list can be a return list. The listing information is displayed in a variety of formats, such as a list of previously purchased items. The digital list 312 includes (or reference to) one or more of the purchased items or wish list items.

The notifications 314 can be selected by the user to access notifications features. The calendar 316 can be selected by the user to access calendar features. The groups 318 can be selected by the user to access group or social features. User input received to select a control element (e.g., digital list 312, notifications 314, calendar 316, or groups 318) can be transmitted by the user device 110 to the notification system 150 over the network 104.

In example embodiments, the notifications 314 can be selected by the user to access notifications messages received by the user device 110. The notification messages can correspond to previously purchased items that the user has requested to return. For example, using the notifications 314, reminders can be set for notifying the user to return an item.

The calendar 316 can be selected by the user to access calendar features. For example, selection of the calendar 316 causes the first frame 310 to present a calendar view with a number of calendar events depicted. The calendar events correspond to scheduled appointments, meetings, and/or the like events. Calendar event data can be synced from a calendar application of a third-party application.

The groups 318 can be selected by the user to access group or social features. For example, selection of the groups 318 causes the first frame 310 to present a list of groups of users, within each of which are digital lists that are shared by the members of the group. The group is formed based on a social network and/or a social graph relationship structure. In some instances, a user can select which members of the group to receive notification messages from or to share notification messages with. For example, when the user is away on travel, the notification message can be shared with a member from the group (e.g., spouse) to return the item on behalf of the user.

Notification attributes that define notification events are created in a number ways. For example, while adding an item to digital list, a user is prompted to define a notification event or not. If the user selects to create a notification event, a menu is presented to the user to provide a number of choices to the user. For example, the user chooses between a location-based (e.g., GPS) trigger and an event-based (e.g., calendar data) trigger. Alternatively, a notification event is created by the user selecting a display element (e.g., an image of the item) that represents the selected item of the item list in order to create a notification event linked to the item. In example embodiments, examples of notification events include a sale, price change, quantity availability, or other characteristics that can affect either the decision to purchase or the timing of a purchase.

If the user selects a location-based trigger, the user device 110 presents to the user an interface display having an element for receiving user input to specify a threshold distance from the vendor (e.g., store). For instance, if the notification system 150 detects that the user is within a threshold distance of the store having the selected item in inventory, the notification system 150 provides the user a notification message. In some example embodiments, if the user does not provide a distance, a default value will be used (e.g., a 2 mile radius). The default value can be user selectable. Furthermore, the user can select threshold distances on individual item and/or store basis. In this way, the user prioritizes purchases.

If the user selects an event-based trigger, then the user device 110 presents a calendar that the user uses to associate calendar notifications with items from the digital list. In this way, items, occasions, and notifications are presented on a common interface.

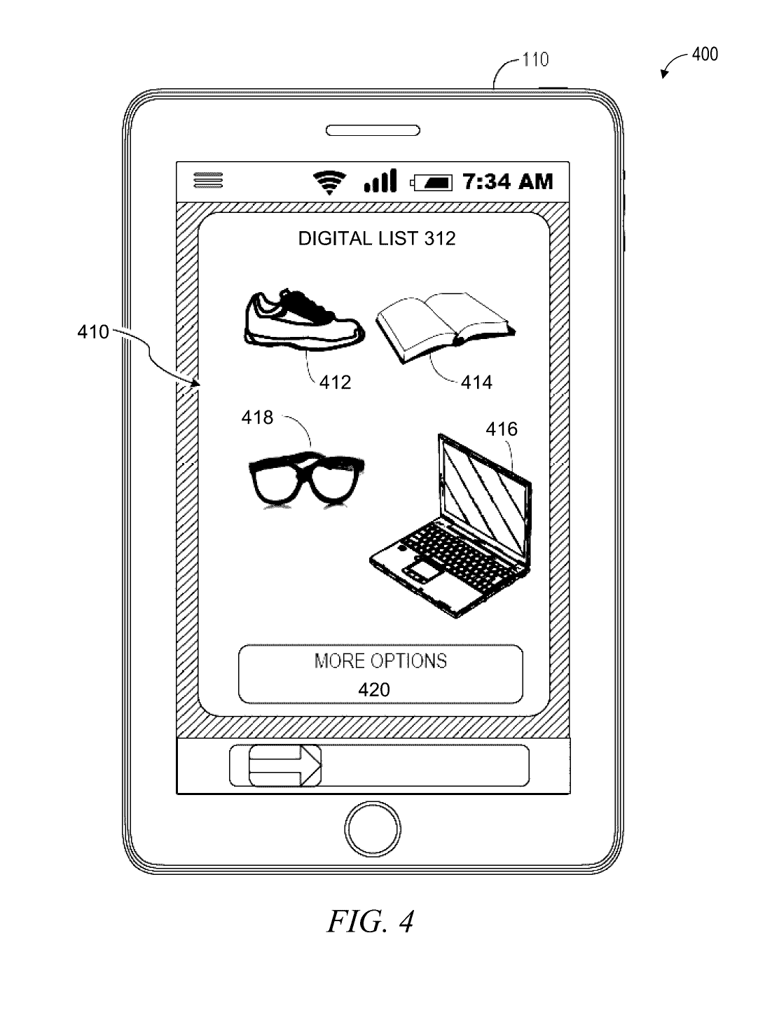

FIG. 4 is an interface diagram illustrating a user interface 400 including the user device 110 rendering a second frame 410 of the web resource providing listing services. In an example embodiment, the second frame 410 corresponds to a display of a software application or web application interfaced with the notification system 150. The notification system 150 provides data to the user device 110 to render the second frame 410 in response to the notification system 150 receiving an indication that the user selected the digital list 312 of FIG. 3 to request a display of the user's digital list. User input received by the second frame 410 from the user is transmitted to the notification system 150.

The second frame 410 includes a number of display elements 412-418 and a control element 420 for more options. The display elements 412-418 correspond to items of the digital list linked to the user, such as previously purchased items or a return list. The control element 420 is selectable by the user to control the organization of the displayed display elements 412-418, search the digital list of the user, and/or to filter the digital list of the user to select which types of items to display within the second frame 510.

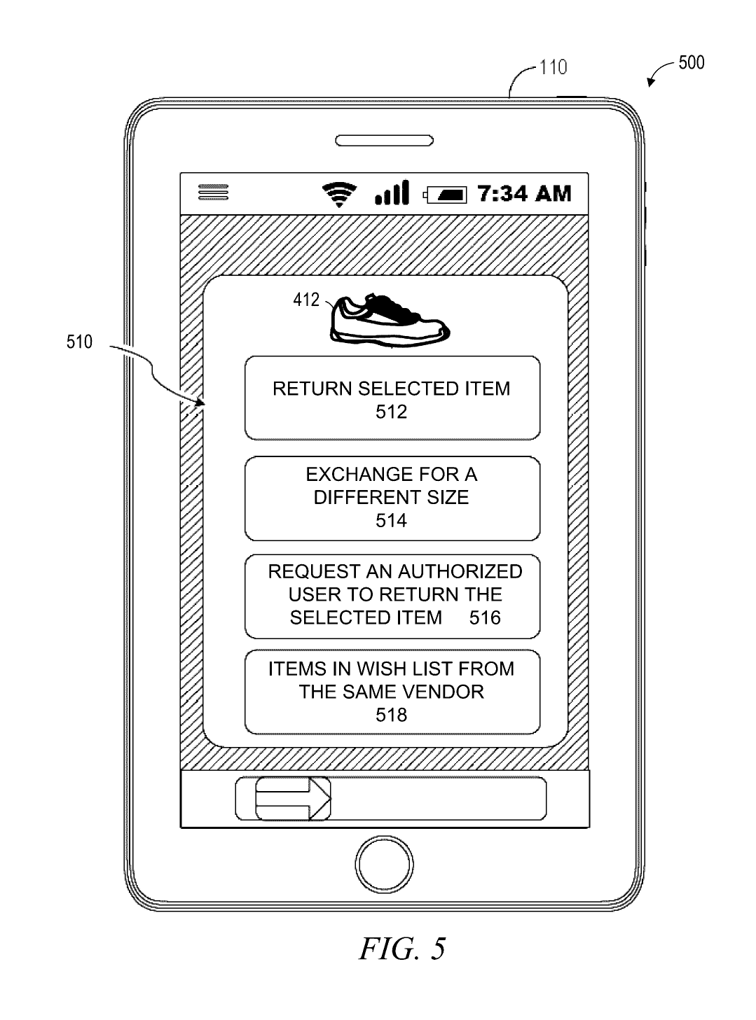

FIG. 5 is an interface diagram illustrating a user interface 500 including the user device 110 rendering a third frame 510 of the web resource providing listing services. In an example embodiment, the third frame 510 corresponds to a display of a software application or web application interfaced with the notification system 150. The notification system 150 provides data to the user device 110 to render the third frame 510 in response to the notification system 150 receiving an indication that the user selected the display element 412 (e.g., sneakers) of FIG. 4. User input received by the third frame 510 from the user is transmitted to the notification system 150.

The third frame 510 includes a number of control elements 512-518 that can be selected by the user for an action corresponding to display element 412. Accordingly, the user device 110, in response to receiving user input of a selection of one of the control elements 512-518, can further display potential actions to be taken with regards to the display element 412.

The control element 512 (e.g., return selected item) is selectable by the user to return the purchased item illustrated by the display element 412. When control element 512 is selected, the user can setup notifications (e.g., location-based notification, event-based notification) to remind the user to return the purchased item. In some instances, the notification system 150 can notify the vendor to send shipping materials in order for the user to return the purchased item illustrated by the display element 412.

The control element 514 is selectable by the user to exchange the purchased item illustrated by the display element 412. When control element 514 is selected, the notification system 150 can notify the vendor via the vendor server(s) to ship to the user the purchased item in a different size. In some instances, the vendor can also send shipping materials in order for the user to return the purchased item illustrated by the display element 412.

The control element 516 is selectable by the user to request an authorized user to return the purchased item illustrated by the display element 412. The authorized user can be a group member selected using the groups 318 interface in FIG. 3. For example, the user can use the notification system 150 to send a request to an authorized user (e.g., group member, a family member, a friend) to return the purchased item when the user is away on a trip.

In some instances, information about the user's account is shared within a selected group using shared data. The shared data includes data that indicates sharing privileges of the user and one or more other users.

The control element 518 is selectable by the user to view items in the user's wish list from the same vendor as the purchased item illustrated by the display element 412. For example, the notification system 150 can setup alerts to return a purchased item when the user is planning to go to the same vendor to obtain another item from the wish list.

In some instances, other control elements can be included in the third frame. An example of another control element includes sending a request (e.g., via the vendor server(s) 130) to the vendor of the purchased item to match a competitor's price for the purchased item.

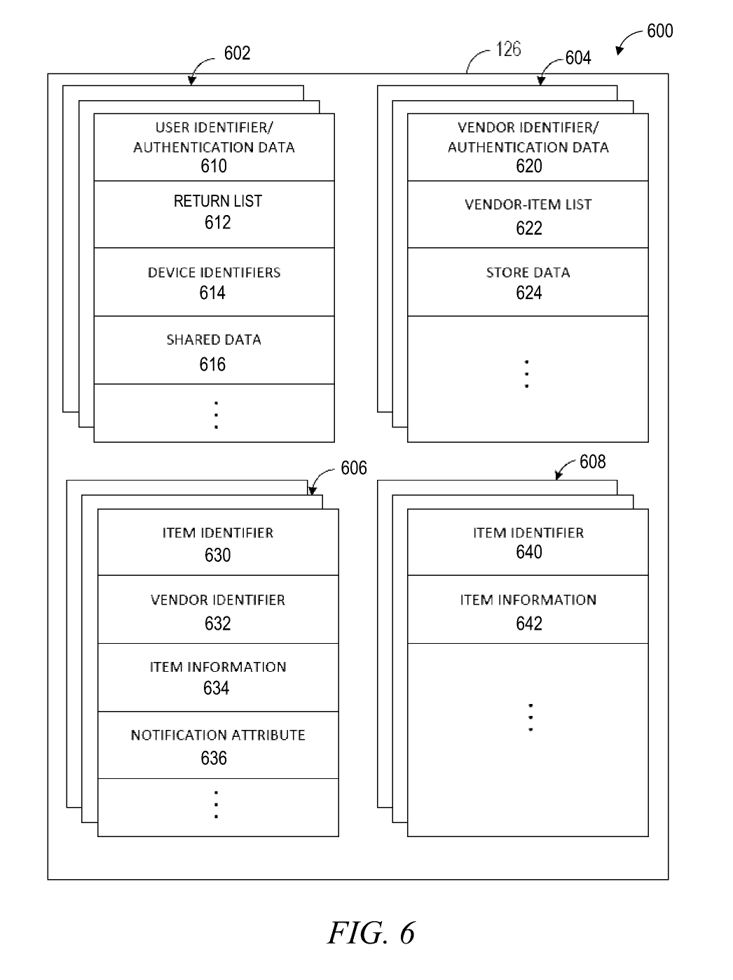

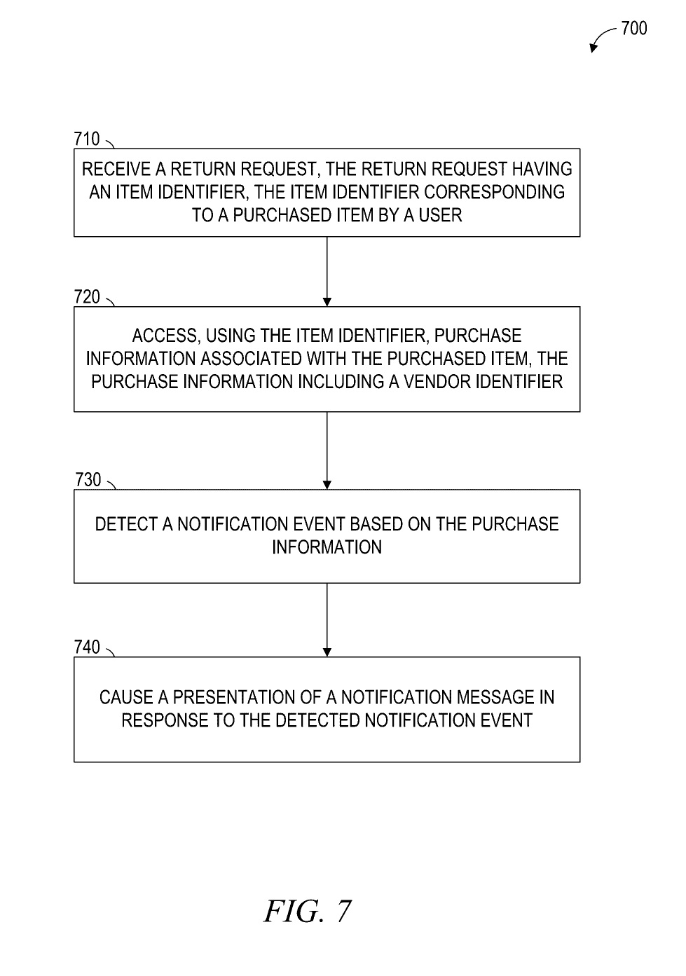

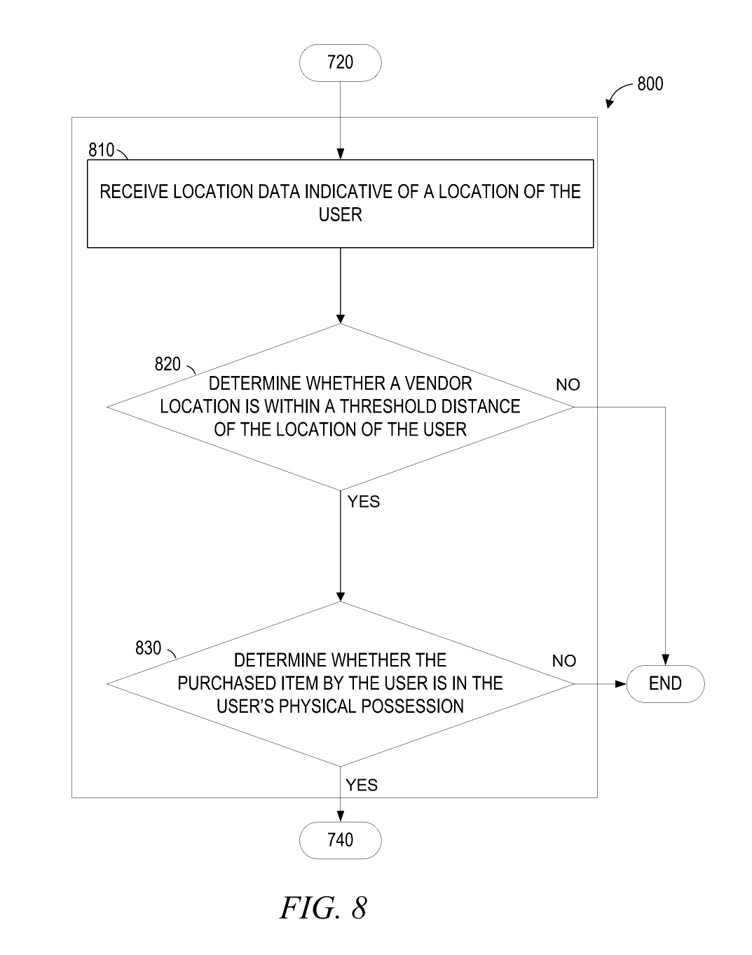

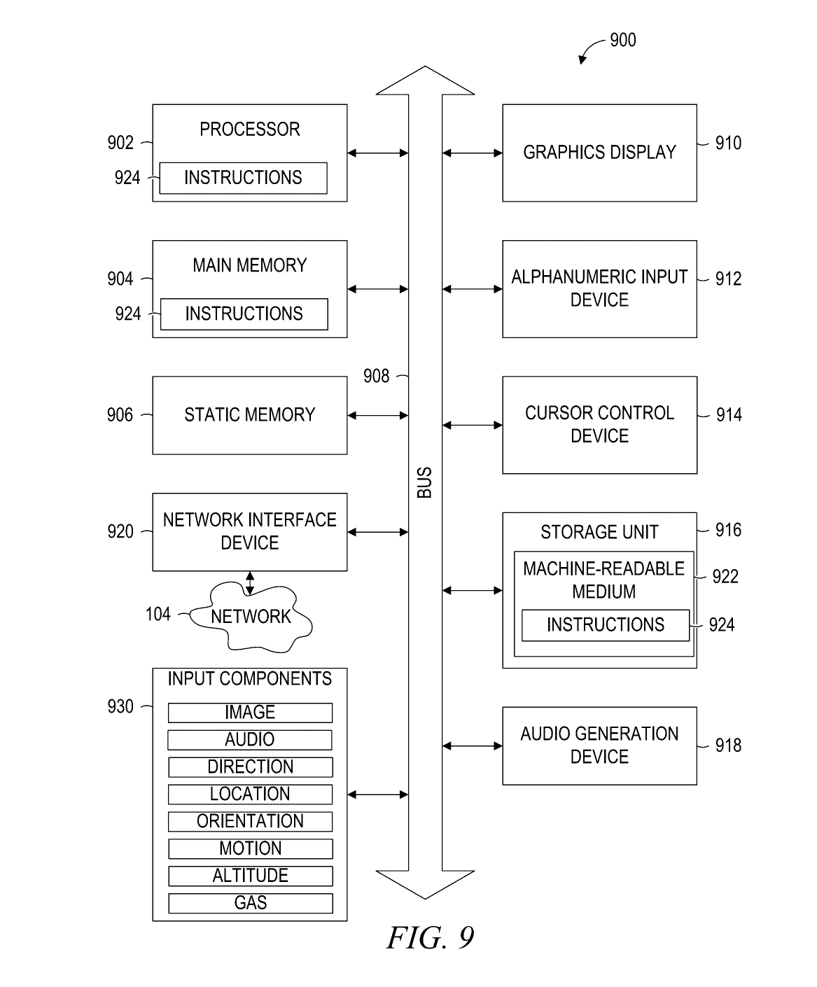

FIG. 6 is a block diagram illustrating an example data memory system 600 including a number of data structures of the notification system 150, in accordance with an example embodiment. The data memory system 600 includes one or more user account 602, one or more vendor account 604, one or more recently purchased item record 606, and one or more vendor item record 608. It will be appreciated that the data of the data memory system 600 are stored together or separately in a number of data storage devices by one or more components of the client-server-based network architecture 100. In an example embodiment, the data memory system 600 is stored by the database(s) 126 of FIG. 1. The data storage interface module(s) 220 (FIG. 2) of the notification system 150 accesses the data memory system 600.

Respective user accounts 602 includes a user identifier data field 610, a return list 612, a device identifiers data field 614, and a shared data field 616. The user identifier data field 610 includes data that link a user to a particular one of the user accounts 602. Furthermore, the user identifier data field 610 includes credential data (e.g., passwords, token-based identifier, and/or biometric data) that are used by the notification system 150 to process authentication requests and verify the identity of the user of the user device 110. The return list 612 includes (or reference to) one or more of the recently purchased item record 606 that the user 106 wants to return, which will be described in greater detail below. The device identifiers data field 614 includes one or more device identifiers of one or more user devices (e.g., user device 110) linked to the corresponding user. In an example embodiment, the device identifiers include data that is usable by the notification system 150 to address the corresponding user devices 110 over the network 104.

The shared data field 616 includes data that indicates sharing privileges of the registered user and one or more other registered users. For example, the shared data field 616 includes data that indicates that the registered user is sharing one or more recently purchased item record 606 with another registered user. Additionally or alternatively, the shared data field 616 includes data that is indicative of sharing notifications with another user who may be a registered user or may not be a registered user. In the case that the second user is not a registered user, the shared data field 616 includes data (e.g., email address, phone number for a text message, etc.) that is usable to address the second user.

Respective vendor accounts 604 includes a vendor identifier data field 620, a vendor-item list data field 622, and a store data field 624. The vendor identifier data field 620 includes data that link a vendor to a particular one of the vendor accounts 604. Furthermore, the vendor identifier data field 620 includes authentication data that are used by the notification system 150 to process authentication requests by vendors and verify the identity of the user of the vendor server(s) 130. The vendor-item list data field 622 includes or reference one or more of the vendor item record 608, which will be described in greater detail below. The store data field 624 includes data that is indicative of one or more attributes of store locations of the vendor. For example, the store data field 624 includes data that is indicative of store locations, store inventories, the approximate locations of items of the store inventory within the store, and the like attributes.

Respective recently purchased item record 606 (e.g., record of a previously purchased item) include an item identifier data field 630, a vendor identifier data field 632, an item information data field 634, and a notification attribute data field 636. The item identifier data field 630 includes data that are used to identify a vendor item of a given vendor. The vendor identifier data field 632 includes data that are used to identify a particular vendor. Accordingly, in example embodiments, the item identifier data field 630 and the vendor identifier data field 632 are used together to uniquely identify a vendor item and a vendor.

The item information data field 634 includes data that is indicative of one or more characteristics and/or attributes of the item identified by the item identifier data field 630 and the vendor identifier data field 632. Examples of characteristics and/or attributes include an image, quantity, size, item type, price, sales, discounts, offers, and/or the like data to describe the selected item.

The notification event (e.g., notification attribute data field 636) includes one or more attributes that are indicative of one or more notification events. As stated, notification events are location-based and/or event-based. For example, in example embodiments, attributes that are location-based indicate a threshold distance from store locations of the vendor identified by the vendor identifier data field 632 or from any suitable locations specified by the user. As such, the notification system 150 provides to the corresponding authorized user a notification when the user (or shared contact) is within the threshold distance from the specified location, such as a store location of the vendor. Additionally or alternatively, in example embodiments, attributes that are event-based correspond to a date, a calendar event (e.g., return date deadline, a birthday of the user or of a contact, an anniversary, business trip, vacation, and so forth). Additionally or alternatively, event-based attributes include sales or other events that impact purchase price, availability (e.g., a selected item becomes available or its local inventory becomes less than a predetermined threshold), and/or the like characteristics that affect a user's ability to acquire the item and/or affects the timing of a user's decision to purchase. In response to the date or event occurring, the notification system 150 provides to the corresponding user a notification.

Respective vendor item records 608 include an item identifier data field 640 and an item information data field 642. The item identifier data field 640 and the item information data field 642 includes data similar to the data that was described above in connection with the item identifier data field 630 and the item information data field 634, respectively.

FIG. 7 is a flowchart illustrating an example method 700 of providing notifications, in accordance with an example embodiment. In this example, the method 700 includes operations such as receiving a request (block 710), accessing purchase information (block 720), detecting a notification event (block 730), and presenting a notification message (block 740). The example method 700 will be described below, by way of explanation, as being performed by certain modules. It will be appreciated, however, that the operations of the example method 700 can be performed in any suitable order by any number of the modules shown in FIG. 2.

In an example embodiment, the method 700 starts at block 710, in which the application interface module(s) 210 receives a return request from a user of a user device, such as the user 106 of the user device 110 of FIG. 1.

At block 710, the application interface module(s) 210 can receive a return request from user 106. The return request can be transmitted using user device 110. The return request can have an item identifier (e.g., item identifier 630). The item identifier can correspond to an item previously purchased by user 106. The item identifier can be added to the return list 612 for notification purposes.

For example, as described in FIGS. 4-5, the application interface module(s) 210 can receive return request such as a selection of the display element 412, and then a selection of the control element 512 to return the previously purchased item corresponding to the display element 412.

The item identifier 630 can correspond to a recently purchased item by user 106. Additionally, the item identifier can be added to the digital list 312 (e.g., such as the return list 612). To this end, the list management module(s) 240 uses the user identifier, vendor identifier, or item identifier of the return request to identify and select the user account 602, the vendor account 604, and the vendor item record 608 of the return request.

Additionally, the list management module(s) 240 updates the return list 612 to include a notification attribute linked to the item identifier 610 associated with the return request. The notification event (e.g., based on a notification attribute 636) is, for example, location-based or event-based, as described below.

In some instances, the return request can include a user identifier and authentication data (e.g., password, user credential). The authentication interface module(s) 230 can authenticate the user based on the user credentials (e.g., username and password). The authentication can authorize access to the digital list 312, calendar 316, groups 318, and so on. In example embodiments, the user device 110 renders a user interface for receiving authentication data from the user 106 and initiating the authentication process. The notification system 150 receives authentication data from the user device 110 via the API server 120 (e.g., where the user device 110 executes an application-based program supporting listing services) and/or via the web server 122 (e.g., where the user device 110 displays a webpage supporting listing services of the notification system 150).

At block 720, the data storage interface module(s) 220 can access purchase information associated with the purchased item using the item identifier. The item identifier can be received at block 710 with the return request. The purchase information can include a vendor identifier. In some instances, the purchase information can include a purchase price, a date of purchase, and other information associated with the vendor accounts 604 (e.g., a vendor identifier data field 620, a vendor-item list data field 622, and a store data field 624). Furthermore, the vendor identifier data field 620 includes authentication data that are used by the notification system 150 to access the vendor server(s) 130.

At block 730, the notification system 150 (e.g., notification management module(s) 250) can detect a notification event based on the purchase information. Various examples are described below to merely illustrate example embodiments of the present disclosure and cannot be considered as limiting the scope of detecting a notification event.

In some instances, the notification system 150 can determine an item location for the purchased item. Additionally, the notification system 150 can determine a vendor location based on the vendor identifier 620, which is included in the purchase information. The notification event can be based on the detection that the item location is within a predetermined distance from the vendor location.

The item location can be obtained by receiving a user input indicative of the item location from the user 106 using the application interface module(s) 210. The user input can include the location of the purchased item, such as the home of the user 106, the car of the user 106, and so on. Alternatively or additionally, the item location can be based on the location of the user device 110 of the user 106. The location of the user device 110 can be determined by the notification management circuitry using location assistance data (e.g., GPS location data).

The vendor location can be based on the vendor identifier 620. Using the vendor identifier 620, the notification system 150 can access the store data 624, which can include the location of the vendor.

A notification event can be detected when the item location is within a predetermined distance from the vendor location. The predetermined distance can be set automatically or by the user 106 using the application interface module(s) 210. For example, a notification event can be detected when the item location is in parking lot of the shopping mall, 1000 feet from the store, one mile from the store, and so on.

For example, a location-based attribute includes a number of parameters, including for example, a distance threshold. Accordingly, an example location-based attribute includes a key-value pair (“distance”, “10 miles”) as a parameter that specifies a notification event occurs if the user is within 10 miles of a store location of the vendor and if the store location has the selected vendor item in inventory.

An event-based attribute includes a number of parameters, including for example, a day and time. Accordingly, an example event-based attribute includes a year-month-day-time tuple, such as (2015, 12, 01, 8:00) as a parameter that specifies a notification event occurs on Dec. 1, 2015 at 8:00 AM. In another example, an example event-based attribute includes an event identifier that is usable to identify stored events of a digital calendar. The digital calendar is stored for example, by the user device 110 or accessible by the user device 110 over the Internet. In example embodiments, a notification attribute includes both location-based attributes and event-based attributes.

In some instances, the purchase information can include a date of purchase, and the notification event is detected when a predetermined number of days have passed since the date of purchase. For example, the vendor may only allow returns within 30 days, so in one example, the notification event (e.g., reminder message) can occur when 25 days have passed since the date of purchase.

In some instances, when the return request includes a user identifier 610, the notification system 150 can access, using the user identifier 610, a wish list for the user. The wish list having items available for sale from a plurality of vendors, such as items that the user 106 would like to purchase. Additionally, the notification system 150 can compare the vendor identifier 620 to the identifiers of the plurality of vendors. The notification event is detected when the vendor identifier matches an identifier from the identifiers of the plurality of vendors. For example, when the user 106 intends to return item from a first store, and the wish list includes an item from the same first store, the notification event can be detected when the notification system 150 sends a notification corresponding to the wish list. To illustrate, in addition to the user 106 receiving a notification to purchase a wish list item from the first store, the user 106 also receives a notification to return a purchased item to the first store.

In some instances, when the return request includes user identifier 610, the notification system 150 can access, using the user identifier 610, sharing privileges of the user. The sharing privileges of the user include a list of authorized users. The sharing privileges can be receiving from user by selecting members (authorized users) to add to the groups 318 category in FIG. 3. Additionally, the notification system 150 can select an authorized user from the list of authorized users based on the sharing privileges of the user and the vendor identifier. The notification message can be presented on a device associated with the authorized user. The notification message can be a text message sent to the authorized user to remind the authorized user to return the purchased item. For example, the authorized user (e.g., friend, spouse) of the user 106 can receive a notification message to return the purchased item. In one example, the authorized user (e.g., friend) can be notified when the user 106 is out of town and cannot physically return the purchased item.

Additionally, once the authorized user (e.g., friend) is selected, the notification system 150 can access a wish list for the authorized user (e.g., friend). As previously discussed, the wish list can have items available for sale from a plurality of vendors. The notification system 150 can compare the vendor identifier to the identifiers of the plurality of vendors. The notification event can detect when the vendor identifier matches an identifier from the identifiers of the plurality of vendors. For example, when the authorized user (e.g., friend, spouse) is notified of an item on his/her wish list, the notification system 150 can also send a notification message to the authorized user to return the purchased item.

At block 740, the notification system 150 can cause a presentation of a notification message in response to the detected notification event at block 730. The notification message can be, but not limited to, a text message, a phone call, an email, and other types of reminder messages. As previously described, the notification event at block 730 is detected based on the purchase information (e.g., location of the item to return being close to the vendor location).

In some instances, the notification system 150 can access, using the vendor identifier, a vendor server of a vendor. The vendor server 130 can have a vendor application 132. The notification message is presented on the vendor application 132. For example, the notification message being a request for the vendor to send materials (e.g., shipping materials) to the user for returning the purchased item. Additionally, the notification message being a request for the vendor to send a different size of the purchased item to the user.

In some instances, the return request can include a device identifier, such as device identifiers 614. The notification system 150 can determine, using the device identifier, a plurality of connected devices linked the user. Additionally, the notification message can be presented on a device from the plurality of connected devices. For example, the device identifier can be associated with a cell phone linked to the user 106, and the notification message can be presented on a tablet linked to the user 106.

The notification message can be determined or defined either based on user input received by the notification system 150 and/or by a default value if the user does not specify a notification message. In some instances, the notification message can be determined based on the notification attribute 636, which can be set by, the notification system 150, the user 106, or the vendor server 130. For example, in response to the user selecting a vendor item to be added to the return list 612 within a web resource of an online marketplace, the user device 110 displays an interface for the user to specify the type of notification message to receive. For example, the user enters in the threshold distance into a text input box to define a location-based attribute, and the user enters event-based attributes by selecting dates/events of an interface displaying a calendar. The user device 110 provides to the notification system 150 the user input. If no user input is provided, the listing service 150 uses a default notification attribute, such as a location-based attribute specifying a threshold distance of a predetermined value (e.g., 3 miles).

The notification system 150 pushes notification messages to the one or more user devices and/or transmits the notification messages in response to the one or more user devices pulling the messages. As stated, in example embodiments, the notification message includes a control element that is user-selectable to share the notification message with a second user.

The notification system 150 pushes notification messages based at least partly on the device identifiers data field 614 of the user account 602. For example, the device identifiers data field 614 is usable to determine addresses (e.g., IP addresses and/or phone number) of the one or more user devices of the user over the network 104. For example, the notification system 150 accesses the user account 602 and determines the addresses of the user devices based on the device identifiers data field 614. In turn, the notification system 150 provides the notification message to the one or more user devices based on the determined addresses.

In some instances, the method 700 can include an authentication process that is described below in the example context of being generated by a webpage of an online marketplace of a vendor. For instance, to access listing services (e.g., digital list 312) within the online marketplace, the webpage of the online marketplace includes a sign-in component to facilitate authentication of the user 106 of the user device 110, and the vendor server 130 sends authentication data to the notification system 150. In turn, the notification system 150 processes the authentication and provides to the vendor server 130 the results (e.g., pass or fail) of the authentication. If an authentication is validated, the vendor server 130 enables the listing services of the online marketplace for the user 106.

Example embodiments of the processing of the authentication request includes selecting user account data and verifying that the credentials of the authentication request matches an expected value stored in the selected user account data. For example, the authentication interface module(s) 230 selects a user account 602 that has an identifier stored within the user identifier field 610 that matches the user identifier of the authentication request. Furthermore, the notification system 150 compares the credential (e.g., password) of the authentication request with the credential (e.g., password) stored within the user identifier data field 610 of the selected user account 602 to determine whether the authentication request passes authentication. For example, authentication passes if the user identifier and password of the authentication request matches the user identifier and authentication data stored in the user identifier data field 610. Matching is determined based on direct matching or indirectly based on passing the credential of the request and/or the authentication request using a mapping function (e.g., a hash function).

In response to a determination that the user authentication request passes authentication, the authentication interface module(s) 230 authenticates the user device to a server of the vendor. For example, the notification system 150 returns to the vendor server 130 data indicative of passing authentication that causes the vendor server 130 to enable on the user device 110 graphical interface elements (e.g., user-selectable control elements) that are associated vendor items. The control elements are each be selectable to generate add-item requests that are sent to the notification system 150 to add the associated vendor item to the digital list of the user.

As described above, the user 106 initiates the authentication process via a website of a vendor. It will be appreciated that in example embodiments the user 106 generates authentication requests in a number of additional or alternative ways. For example, the online marketplace links the online marketplace to the notification system 150 such that when the user 106 requests to sign in for listing services, the online marketplace transfers the user 106 to the notification system 150 for authentication. That is, in example embodiments, the notification system 150 provides a webpage (e.g., user interface 300) to the user 106 for authenticating the user 106 instead of the online marketplace of the vendor server 130. Thus, the notification system 150 directly prompts the user 106 for authentication requests, receives authentication requests, processes authentication requests, and provides to the vendor server 130 the results (e.g., pass or fail) of the authentication. In another example, an application (e.g., a software application for a mobile device and/or a desktop computer) executed on the user device 110 provides a GUI (e.g., user interface 300) to the user 106 for authenticating the user 106. The application corresponds to a software application dedicated to an online marketplace (e.g., an application for a particular vendor) and/or an application for providing direct access to the notification system 150 (e.g., user information, purchase information, vendor information, group information). The listing server 150 receives authentication data from the application, processes the application data, and returns the results to the application.

The authentication interface module(s) 230 also serves to authenticate vendors. For example, in operation, the authentication interface module(s) 230 receives a vendor authentication request from the vendor server(s) 130. In response, the authentication interface module(s) 230 determines whether the vendor authentication request passes authentication. The determination of whether an authentication passes is based on matching the vendor identifier data field 620 (which includes a vendor identifier and credential data) to the vendor identifier and credential data included in the vendor authentication request. Furthermore, in response to a determination that the vendor authentication request passes authentication, the authentication interface module(s) 230 authenticates the vendor server(s) 130 to allow the vendor server(s) 130 data linked to the vendor account, as de.

In example embodiments, authenticated vendor server(s) 130 accesses data and/or services that are linked to the recently purchased item records 606 that correspond to a vendor item (e.g., a vendor item record 608) of the vendor. For example, vendors push notifications (e.g., sales, discounts, offers, and/or the like alerts) to users that have vendor items linked (e.g., added to a digital list) to the respective vendors. Additionally or alternatively, the notification system 150 (e.g., via the list management module(s) 240) provides analytics data to a vendor, where the analytics regard, e.g., a number of users that have vendor items of the vendor included in their recent purchases field 612 and/or the number of selected vendor items of the vendor that have been included in the recently purchased item records 606. In example embodiments, the analytics provide no indication of selection of the vendor items from other vendors.

The authentication interface module(s) 230 can protect the privacy of the users and vendors. For example, in example embodiments, the authentication interface module(s) 230 presents to a user a privacy setting that is selected to prevent the recent purchases field 612 from being shared with other users and/or vendors without the users' permission. Additionally or alternatively, the authentication interface module(s) 230 presents to the vendors a privacy setting that is selected to prevent data related to their vendor-item lists from being shared with other vendors.

FIG. 8 is a flowchart illustrating an example method 800 of detecting a notification event of FIG. 7, in accordance with an example embodiment. Elements common to FIGS. 7 and 8 share common reference indicia, and only differences between the figures are described herein for the sake of brevity. The example block 730 performs detection of a notification event that is specified by a location-based notification event. That is, a notification event corresponds to the user being within a predetermined threshold of one of the store locations of the vendor. The method of the example block 730 will be described below, by way of explanation, as being performed by certain modules. It will be appreciated, however, that the operations of the method of the example block 730 can be performed in any suitable order by any number of the modules shown in FIG. 2.

At block 810, the notification system 150 receives location data indicative of a location of the user 106. The user location data can correspond to GPS location data generated by the user device, such as the user device 110 of FIG. 1, and that is sent to the notification system 150. The notification system 150 can have access to the location services of the user device 110 in order to receive location data of the user.

At block 820, the notification system 150 determines whether a vendor location is within a threshold distance of the user's location. The vendor location can be based on location data indicative of the location of the vendor. For example, using the vendor identifier from the purchase information, the notification system 150 can determine the location of the vendor corresponding to the vendor identifier. In response to a determination that the vendor location is not within the threshold distance, the block 730 ends.

On the other hand, in response to a determination that there is the vendor location within a threshold distance, the block 730 moves to block 830 for determining whether the purchased item by the user is in the user's physical possession. For example, based on a user input, such as a confirmation that the purchased item is with the user, the notification system 150 can determine whether the purchased item is in the user's physical possession. In another example, the purchased item may have an radio-frequency identification (RFID) tag that allows the user device 110 or the notification system 150 to determine if the purchased item is within the user's physical possession (e.g., close proximity of the user). The purchased item can be the purchased item from block 710. Additionally, the purchased item can be an item from the return list 612. In response to a determination that the purchased item is not in the user's physical possession, the block 730 ends. Alternatively, in response to the purchased item being in the user's physical possession, the notification system 150 detects and sets a notification event at block 730. Subsequently, based on the notification event, a notification message is presented to the user 106 at block 740.

In a first scenario, a user input from user device 110 may have been sent to inform the notification system 150 that the item in the return list 612 is in user's possession (e.g., in the car of the user). In a second scenario, the data storage interface module(s) 220 can accesses the return list 612 to determine the location of the item in order to determine if the item is in the user's physical possession. Continuing with the second scenario, the notification system 150 can initially notify the user 106 (e.g., when the user 106 is a home) to go to return the item, and in response receive a confirmation from the user. The confirmation can include an acknowledgement that the item in the return list is in the user's physical possession (e.g., has been placed in the car).

In the case that it is determined that the item in the return list 612 is in the user's possession, the notification system 150 makes a determination that a notification event of the first item has been detected. In turn, the method of the example block 840 continues to block 740. In example embodiments, the example block 730 repeats blocks 810-840 for each item of the user's return list 612.

In other example embodiments, a first user and a second user can create a relationship to share data (e.g., shared data 616 using groups 318 interface) within the notification system 150 in a number of ways. For example, the first user can create a relationship using the groups 318 interface by authorizing the notification system 150 to access contact information (e.g., contacts stored on the user device 110, an email account, a social network website, and so forth) to facilitate the creation of groups and/or “circles.” The shared data 616 can included the authorized list of users that the notification system can contact. As an illustrative example, the first user selects the second user from a contact list stored on the first user's mobile phone to form a group (e.g., group 318) to share location and/or digital-list data. The first user can select one or more additional users to include in the group. The group can have a social network or a social graph (or circle) structure. The first user can select to share one or more list items (e.g., items included in a digitals list of the first user) and/or location data to share with the group. In some instances, the digital list 312 can be the return list 612 or a wish list. In this way, members of the group have access to data that is indicative of the shared list items and/or location of the first user.

In example embodiments, as stated, the location of the first user can be shared with the second user and/or the group. For instance, as a particular illustrative example, a first user elects to share his location (e.g., by making his location data accessible) with a group of contacts. In operation, the first user visits (or is within a threshold distance of) a store location of a vendor. A second user of the group receives a notification from the notification system 150 if the second user has selected the vendor to request receiving notifications when another user visits a store location of the vendor.

Furthermore, in example embodiments, the second user can elect to share items to return from the second user's digital list with the first user and/or the group.

Additionally or alternatively, in example embodiments, the notification system 150 sends a notification message to the first user based on location data of the first user relative to store locations linked to an item of the second user. This type of detection facilitates sharing and gifting between multiple users. For example, the shared data field 616 includes data that is indicative of a request by the first user to allow the second user to generate notification messages for the first user. As a non-limiting illustrative example, the first user corresponds to the child of the second user.

According to some embodiments, the notification event can be based on a calendar event. For example, the notification system 150 accesses current event data, such as a current date and time. Additionally, the notification system 150 determines whether the current event data matches the notification event of the first item. For example, the notification event specifies a target date and time. As such, the current event data matches the notification event if the current time is equal to or is later than the target date and time.

The notification system 150 creates a notification event based on a calendar time. For example, in response to receiving an add item request to the return list 612 from a user, the notification system 150 accesses calendar data that is indicative of a calendar event. Examples of calendar events include a target date and time, a reoccurring date (e.g., the first Monday of each month), and the like. Calendar data are provided by a third party application, such as a third-party social network application or software (e.g., profession productivity software). The notification system 150 receives user input from the user device that is indicative of a request to link the calendar event to the first item. In response, the notification system 150 updates the calendar data by linking the first item to the calendar event. A notification event is indicative of the calendar data that is linked to the first item is stored in the notification attribute data field 636 of the corresponding selected item record 606.

FIG. 9 is a block diagram illustrating components of a machine 900, according to some example embodiments, able to read instructions 924 from a machine-readable medium 922 (e.g., a non-transitory machine-readable medium, a machine-readable storage medium, a computer-readable storage medium, or any suitable combination thereof) and perform any one or more of the methodologies discussed herein, in whole or in part. Specifically, FIG. 9 shows the machine 900 in the example form of a computer system (e.g., a computer) within which the instructions 924 (e.g., software, a program, an application, an applet, an app, or other executable code) for causing the machine 900 to perform any one or more of the methodologies discussed herein may be executed, in whole or in part. The server 202 can be an example of the machine 900.

In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a distributed (e.g., peer-to-peer) network environment. The machine 900 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include any collection of machines that individually or jointly execute the instructions 924 to perform all or part of any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein.

The machine 900 may further include a graphics display 910 (e.g., a plasma display panel (PDP), a light emitting diode (LED) display, a liquid crystal display (LCD), a projector, a cathode ray tube (CRT), or any other display capable of displaying graphics or video). The machine 900 may also include an alphanumeric input device 912 (e.g., a keyboard or keypad), a cursor control device 914 (e.g., a mouse, a touchpad, a trackball, a joystick, a motion sensor, an eye tracking device, or other pointing instrument), a storage unit 916, an audio generation device 918 (e.g., a sound card, an amplifier, a speaker, a headphone jack, or any suitable combination thereof), and a network interface device 920.

The storage unit 916 includes the machine-readable medium 922 (e.g., a tangible and non-transitory machine-readable storage medium) on which are stored the instructions 924 embodying any one or more of the methodologies or functions described herein. The instructions 924 may also reside, completely or at least partially, within the main memory 904, within the processor 902 (e.g., within the processor's cache memory), or both, before or during execution thereof by the machine 900. Accordingly, the main memory 904 and the processor 902 may be considered machine-readable media 922 (e.g., tangible and non-transitory machine-readable media). The instructions 924 may be transmitted or received over the network 34 via the network interface device 920. For example, the network interface device 920 may communicate the instructions 924 using any one or more transfer protocols (e.g., hypertext transfer protocol (HTTP)).

The machine-readable medium 922 may include a magnetic or optical disk storage device, solid state storage devices such as flash memory, or other non-volatile memory device or devices. The computer-readable instructions 924 stored on the computer-readable storage medium 922 are in source code, assembly language code, object code, or another instruction format that is interpreted by one or more processors 902.

In some example embodiments, the machine 900 may be a portable computing device, such as a smartphone or tablet computer, and have one or more additional input components 930 (e.g., sensors or gauges). Examples of such input components 930 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 922 able to store data temporarily or permanently and may be taken to include, but not be limited to, random-access memory (RAM), read-only memory (ROM), buffer memory, flash memory, and cache memory. While the machine-readable medium 922 is shown, in an example embodiment, to be a single medium, the term “machine-readable medium” should be taken to include a single medium or multiple media (e.g., a centralized or distributed database, or associated caches and servers 202) able to store the instructions 924. The term “machine-readable medium” shall also be taken to include any medium, or combination of multiple media, that is capable of storing the instructions 924 for execution by the machine 900, such that the instructions 924, when executed by one or more processors 902 of the machine 900 (e.g., the processor 902), cause the machine 900 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory, excluding signals) data repositories in the form of a solid-state memory, an optical medium, a magnetic medium, or any suitable combination thereof.

The foregoing description, for purposes of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the present disclosure and its practical applications, to thereby enable others skilled in the art to best utilize the present disclosure and various embodiments with various modifications as are suited to the particular use contemplated.

Throughout this specification, plural instances may implement components, operations, or structures described as a single instance. Although individual operations of one or more methods are illustrated and described as separate operations, one or more of the individual operations may be performed concurrently, and the operations can be performed in a different order than illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 922 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors 902) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 902 or other programmable processor 902. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 902 configured by software to become a special-purpose processor, the general-purpose processor 902 may be configured as respectively different special-purpose processors (e.g., comprising different hardware modules) at different times. Software (e.g., a software module) may accordingly configure one or more processors 902, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 902 that are temporarily configured (e.g., by software) or permanently configured to perform the relevant operations. Whether temporarily or permanently configured, such processors 902 may constitute processor-implemented modules that operate to perform one or more operations or functions described herein. As used herein, “processor-implemented module” refers to a hardware module implemented using one or more processors 902.

Similarly, the methods described herein may be at least partially processor-implemented, a processor 902 being an example of hardware. For example, at least some of the operations of a method may be performed by one or more processors 902 or processor-implemented modules. As used herein, “processor-implemented module” refers to a hardware module in which the hardware includes one or more processors 902. Moreover, the one or more processors 902 may also operate to support performance of the relevant operations in a “cloud computing” environment or as a “software as a service” (SaaS). For example, at least some of the operations may be performed by a group of computers (as examples of machines including processors 902), with these operations being accessible via a network 34 (e.g., the Internet) and via one or more appropriate interfaces (e.g., an application program interface (API)).

The performance of certain operations may be distributed among the one or more processors 902, not only residing within a single machine, but deployed across a number of machines. In some example embodiments, the one or more processors 902 or processor-implemented modules may be located in a single geographic location (e.g., within a home environment, an office environment, or a server farm). In other example embodiments, the one or more processors 902 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the arts. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving a return request, the return request having an item identifier, the item identifier corresponding to a purchased item by a user;
accessing, using the item identifier, purchase information associated with the purchased item, the purchase information including a vendor identifier;
detecting, using a processor, a notification event based on the purchase information; and
causing a presentation of a notification message in response to the detected notification event.

2. The method of claim 1, further comprising:
determining an item location for the purchased item;
determining a vendor location based on the vendor identifier; and
wherein the notification event is detected when the item location is within a predetermined distance from the vendor location.

3. The method of claim 1, wherein the purchase information includes a date of purchase, and wherein the notification event is detected when a predetermined number of days have passed since the date of purchase.

4. The method of claim 1, wherein the return request includes user identifier, the method further comprising:
accessing, using the user identifier, a wish list for the user, the wish list having items available for sale from a plurality of vendors;
comparing the vendor identifier to the identifiers of the plurality of vendors; and
wherein the notification event is detected when the vendor identifier matches an identifier from the identifiers of the plurality of vendors.

5. The method of claim 1, wherein the return request includes user identifier, the method further comprising:
accessing, using the user identifier, sharing privileges of the user, the sharing privileges of the user having a list of authorized users;
selecting an authorized user from the list of authorized users based on the sharing privileges of the user and the vendor identifier; and
wherein the notification message is presented on a device associated with the authorized user.

6. The method of claim 5, further comprising:
accessing a wish list for the authorized user, the wish list having items available for sale from a plurality of vendors;
comparing the vendor identifier to the identifiers of the plurality of vendors; and
wherein the notification event is detected when the vendor identifier matches an identifier from the identifiers of the plurality of vendors.

7. The method of claim 1, further comprising:
accessing, using the vendor identifier, a vendor server of a vendor, the vendor server having a vendor application; and
wherein the notification message is presented on the vendor application, the notification message being a request for the vendor to send materials to the user for returning the purchased item.

8. The method of claim 1, further comprising:
accessing, using the vendor identifier, a vendor server of a vendor, the vendor server having a vendor application; and
wherein the notification message is presented on the vendor application, the notification message being a request for the vendor to send a different size of the purchased item to the user.

9. The method of claim 1, wherein the return request includes device identifier, the method further comprising:
determining, using the device identifier, a plurality of connected devices linked the user; and
wherein the notification message is presented on a device from the plurality of connected devices.

10. A non-transitory machine-readable storage medium comprising instructions that, when executed by one or more processors of a machine, cause the machine to perform operations comprising:
receiving a return request, the return request having an item identifier, the item identifier corresponding to a purchased item by a user;
determining an item location for the purchased item;
accessing, using the item identifier, purchase information associated with the purchased item, the purchase information including a vendor identifier;
determining a vendor location based on the vendor identifier;
detecting a notification event based on the purchase information based on the item location being within a predetermined distance from the vendor location; and
causing a presentation of a notification message in response to the detected notification event.

11. The storage medium of claim 10, wherein the purchase information includes a date of purchase, and wherein the notification event is detected when a predetermined number of days have passed since the date of purchase.

12. The storage medium of claim 10, wherein the return request includes user identifier, further comprising instructions that cause the machine to perform operations comprising:
accessing, using the user identifier, a wish list for the user, the wish list having items available for sale from a plurality of vendors;
comparing the vendor identifier to the identifiers of the plurality of vendors; and
wherein the notification event is further based on the vendor identifier corresponding to an identifier from the identifiers of the plurality of vendors.

13. The storage medium of claim 10, further comprising instructions that cause the machine to perform operations comprising:
accessing, using the vendor identifier, a vendor server of a vendor, the vendor server having a vendor application; and
wherein the notification message is presented on the vendor application, the notification message being a request for the vendor to send materials to the user for returning the purchased item.

14. The storage medium of claim 10, further comprising instructions that cause the machine to perform operations comprising:
accessing, using the vendor identifier, a vendor server of a vendor, the vendor server having a vendor application; and
wherein the notification message is presented on the vendor application, the notification message being a request for the vendor to send a different size of the purchased item to the user.

15. A system comprising:
a database to store purchase information associated with a purchased item by a user;
an application interface to receive a return request, the return request having an item identifier, the item identifier corresponding to the purchased item; and
a notification management circuitry, having one or more processors, to:
access, using the item identifier, the purchase information associated with the purchased item, the purchase information including a vendor identifier;
detect a notification event based on the purchase information; and
cause a presentation of a notification message in response to the detected notification event.

16. The system of claim 15, wherein the notification management circuitry is further configured to:
determine an item location for the purchased item;
determine a vendor location based on the vendor identifier; and
wherein the notification event is detected when the item location is within a predetermined distance from the vendor location.

17. The system of claim 15, wherein the purchase information includes a date of purchase, and wherein the notification event is detected when a predetermined number of days have passed since the date of purchase.

18. The system of claim 15, wherein the return request includes user identifier, and wherein the notification management circuitry is further configured to:
access, using the user identifier, a wish list for the user, the wish list having items available for sale from a plurality of vendors;
compare the vendor identifier to the identifiers of the plurality of vendors; and
wherein the notification event is detected when the vendor identifier matches an identifier from the identifiers of the plurality of vendors.

19. The system of claim 15, wherein the return request includes user identifier, and wherein the notification management circuitry is further configured to:
access, using the user identifier, sharing privileges of the user, the sharing privileges of the user having a list of authorized users;
select an authorized user from the list of authorized users based on the sharing privileges of the user and the vendor identifier; and
wherein the notification message is presented on a device associated with the authorized user.

20. The system of claim 15, wherein the notification management circuitry is further configured to:
access, using the vendor identifier, a vendor server of a vendor, the vendor server having a vendor application; and
wherein the notification message is presented on the vendor application, the notification message being a request for the vendor to send materials to the user for returning the purchased item.
